(19) United States
(12) Patent Application Publication
(10) Pub. No.: US 2008/0172248 A1
(43) Pub. Date: Jul. 17, 2008

(54) SYSTEM AND METHOD FOR ENABLING HEALTH CARE PROVIDERS TO EFFECT COMPENSATORY INVOICING OF PATIENTS WHO USE A COVERAGE ENTITY IN ADDITION TO THEIR HEALTH INSURER

(76) Inventor: Stephen D. Ambrose, Richmond, VA (US)

Correspondence Address: PILLSBURY WINTHROP SHAW PITTMAN, LLP, P.O. BOX 10500, MCLEAN, VA, 22102, US

(21) Appl. No.: 11/623,528

(22) Filed: Jan. 16, 2007

(51) Int. Cl. G06Q 50/00

(52) U.S. Cl. 705/2

(57) ABSTRACT

A system and method is provided for compensatory invoicing of a patient for health care services rendered by a Health Care Provider. The system and method enables a Health Care Provider to obtain payment of Full Rates for services rendered to a patient in circumstances where a Health Insurance Entity provides less than full-rate compensation (e.g., compensation at Contracted Rates) to the Health Care Provider AND the patient has been reimbursed additionally by another payment party for claims already paid for by the Health Insurance Entity. In one implementation, the patient contracts with the Health Care Provider to ensure that the Health Care Provider is fully compensated for the services rendered after the patient receives payments from a First and/or Third Party Payment Entity (e.g., an auto insurance carrier, worker's compensation insurance carrier, Medpay, PIP etc.) for the services. The invention tracks claim(s) filed by the patient against the First and/or Third Party Payment Entity and tracks payment(s) made by the First and/or Third Party Payment Entity to the patient. The patient and/or the First and/or Third Party Payment Entity is then billed for the difference in payments made to the Health Care Provider by the Health Insurance Entity, effecting compensatory invoicing for a Full Rate fee chargeable by the Health Care Provider in cases when a First and/or Third Payment party has reimbursed the patient for similar services as already reimbursed by the Health Insurance Entity.

### FIELD OF THE INVENTION

The invention relates to systems and methods for health providers and related parties to effect compensatory invoicing of patients who utilize a coverage entity with respect to their health care service bills, in addition to their health insurance, pursuant to a Collateral Source Rule or otherwise.

### BACKGROUND OF THE INVENTION

In the current health care arena, physicians, hospitals, and other health care providers (hereinafter the “Health Care Provider”) contract with health insurance companies, managed care organizations (“MCOs”), or other health insurance providers (hereinafter the “Health Insurance Entity”). Typically, both a Health Care Provider and a patient have a contractual relationship with a Health Insurance Entity. In general, when a patient visits an “in-network” Health Care Provider, the patient receives services which are subsequently billed to the Health Insurance Entity by the Health Care Provider. The Health Insurance Entity is typically the primary payer for services and will cover necessary treatment and care for the patient's various health problems, including acute injuries.

Upon contracting with the Health Insurance Entity, the Health Care Provider generally agrees to accept contracted rates set by the Health Insurance Entity (hereinafter “Contracted Rates”). These Contracted Rates are typically lower than the normal, full-rate fees charged by the Health Care Provider (hereinafter “Full Rates”) for the delivery of a variety of billable services. In return, the Health Care Provider is given access to the Health Insurance Entity's patients, some of whom may be assigned to the Health Care Provider. The Health Care Provider also agrees that, during the term of the patient's coverage by the Health Insurance Entity, if the patient is to be billed for the Health Care Provider's services directly for any reason, the Health Care Provider can only bill at the Contracted Rates for the services performed, provided that these are services normally paid for by the Health Insurance Entity.

In most Health Insurance Entity/Health Care Provider contracts, the Health Care Provider is prohibited from billing a patient for any amounts attributable to the difference between the Health Care Provider's Full Rates and the Contracted Rates. This type of billing, is known commonly as “Balance Billing” (i.e., billing the patient for the balance between the Contracted Rates and the Full Rates). The difference in rates can sometimes be quite large. Thus, while a Health Care Provider obtains some benefits from contracts with Health Insurance Entities, certain financial drawbacks exist.

When a patient visits a Health Care Provider for medical attention for injuries, symptoms, or disease stemming from an accident or other event for which a liability insurance product is applicable (hereinafter a “Covered Event”), there may be instances when one or more parties other than a Health Insurance Entity, such as a first or third party payer may make payments for the services. For example, in the case of an auto accident, the first party payer may be the auto insurance insurer for any injured individual through an attached medical payment rider, regardless of fault in the accident (hereinafter “Medpay”) or the insurer for any auto insurance rider known as Personal Injury Protection (hereinafter “PIP”). Medpay, PIP insurers and other first party payment entities can be referred to as a first party payer (hereinafter “First Party Payment Entity”). An example of a third party payer may be the automobile (or other) liability insurance company for the driver (or other entity) who was “at-fault” or responsible for the Covered Event, e.g. for causing the auto (or other) accident and the injuries for which the injured, non-responsible party received treatment. Third party payers, for example, may include auto insurance carriers, liability and worker's compensation insurance carriers, and other third party payers, among other types of entities (hereinafter “Third Party Payment Entity”). For example, if a patient visits a Health Care Provider because he or she was in an automobile accident, the patient's Health Insurance Entity may be billed, and the patient's Health Insurance Entity may subsequently pay medical bills to the Health Care Provider who provided services to the patient. In some instances, the Health Insurance Entity may elect to seek reimbursement for monies paid for services from a First and/or Third Party Payment Entity who has also paid monies for similar health services, through a process known as subrogation.

However, in many jurisdictions (e.g., states), there is a legal doctrine known as the ‘Collateral Source Rule’ that allows an injured patient to submit his or her medical bills to a First Party Payment Entity, a Third Party Payment Entity or both, if applicable, for payment, even if the bills have already been paid by the Health Insurance Entity to the respective health care provider(s). The Collateral Source Rule prohibits the admission at trial of evidence that a patient's injuries were already compensated from a health insurance policy or other source of compensation. For example, in a personal injury case, evidence that a Plaintiffs medical bills were paid by his or her medical insurance are not admissible. This is largely because the Collateral Source Rule is intended to promote justice and assess remedies for fault of the tortfeasor (the entity or entities that caused the injury).

Additionally, some insurance or other payment sources that pay for an injured party's damages may gain a lien or right of subrogation in any ultimate recovery by or on behalf of the injured party. In these circumstances, the injured patient must pay back the party with the subrogation right, who had previously paid on charges from Health Care Provider(s), assuming the patient received additional payment for the same billed services by other payment sources other than the party with the subrogation rights.

One problem with this system is that complete and full rate payment may not be made to the Health Care Providers for services performed and billed. Attorneys and/or injured parties however, can submit the Health Care Provider's medical bills to a First and/or Third Party Payment Entity and can receive full compensation at Full Rates, even if the medical bills were already paid. Thus, the Health Care Provider receives payment at the lower Contracted Rates, while the patient and attorney are compensated from the First and/or Third Party Payment Entity at the higher Health Care Provider's Full Rates.

Additionally, many Health Care Provider/Health Insurance Entity contracts provide for a waiver of subrogation on the Health Care Provider's part. Subrogation is a legal concept where one entity assumes the legal rights of another entity for whom the first entity has paid expenses or a debt on their behalf. For example, when an insurer is required to pay a claimant a sum of money, the insurer usually is allowed to sue in the name of the claimant against any person who was responsible for the loss. This concept enables an insurance company to sue on behalf of its insured if it is required to pay the insured for a loss caused by another entity. Subrogation is generally considered in most legal systems to form part of the law of restitution by preventing unjust enrichment. In other words, subrogation prevents the subrogor (e.g., the patient) from receiving funds from the subrogee (e.g., the health care insurer), and then still claiming the original sum of money from the tortfeasor (e.g., the entity that caused the accident). Pursuant to the waiver of subrogation, the Health Insurance Entity may be able to recover any payments made for services provided to a patient following an auto accident or other Covered Event, provided that the First and/or Third Party Payment Entity paid monies for the same set of services. Thus, even if the Health Insurance Entity receives payment at the Full Rates, the Health Care Provider gets nothing more than the Contracted Rates. In this sense, patients, attorneys and other parties can leverage the Health Care Provider's efforts to financially benefit for themselves, while the Health Care Provider receives only the Contracted Rates.

These and other drawbacks exist with known billing practices.

### SUMMARY OF THE INVENTION

The invention addressing these and other drawbacks relates to a system and method for enabling a Health Care Provider to effect compensatory invoicing of patients for a Covered Event in instances where the patient has contracted with a Health Insurance Entity for provision of health care services at a Contracted Rate and a First and/or Third Party Payment Entity is liable for payment due to the Covered Event.

According to an aspect of the invention, a Health Care Provider may take one or more steps to ensure that it is in a legal position to effect compensatory invoicing of a patient to effectively bill a patient, while honoring the Health Care Provider/Health Insurance Entity Contract (under certain circumstances) by enforcing a billing arrangement which would enable the Health Care Provider to be paid their Full Rate when a patient (or an agent of the patient) chooses to collect payment from a First and/or Third Party Payment Entity other than their Health Insurance Entity.

For example, in one implementation, a Health Care Provider, prior to rendering services to a new (or current) patient who is seeking care stemming from an accident (or other Covered Event), requires the patient to sign a legal contract between the patient and the Health Care Provider, specifically outlining the billing policies of the Health Care Provider, where the contract includes a provision entitling the Health Care Provider to be entitled to their Full Rate (not the Contracted Rate) if the patient uses the Health Care Provider's bills for compensation by submitting the bills to a First and/or Third Party Payment Entity (e.g., an entity other than the Patient's Health Insurance Entity).

Once a signed contract is in place by and between the patient and the Health Care Provider, the Health Care Provider provides necessary services to the patient in the ordinary course, bills the Health Insurance Entity at the Contracted Rates, and receives payment from the Health Insurance Entity for the rendered services at the Contracted Rates.

Subsequently, the Health Care Provider (or someone on behalf of the Health Care Provider) may monitor a variety of sources to determine whether the patient has filed a claim with a First and/or Third Party Payment Entity and/or received compensation from a First and/or Third Party Payment Entity relating to services provided by the Health Care Provider. Monitored sources may, for example, include Court records (electronic or otherwise) as well as the use of various health provider and billing databases, many of which are currently known (but used for other purposes). This may also include providing a questionnaire with the paperwork which the patient fills out and signs at the Health Care Provider's office prior to, during or subsequent to treatment, asking if the injury or reason the patient is seeking care stems directly from an accident or Covered Event, and if so, identification of any First and/or Third Party Payment Entities. The requesting of treatment records, bills, statements, etc. either by the patient or a representative (agent) of the patient may also be a trigger, alerting the Health Care Provider and related staff that compensatory invoicing may be appropriate.

Monitoring may further be performed manually and/or electronically at predetermined intervals or otherwise. Additionally, the patient may also allow the Health Care Provider to bill the First and/or Third Party Payment Entity on the patient's behalf. Whichever the case, the Health Care Provider (or agent) enforces the billing contract between the Health Care Provider and the patient to effect compensatory invoicing and collect the difference between the Full Rates and the Contracted Rates in appropriate circumstances.

According to an aspect of the invention, a system is provided, which enables the review and subsequent auditing of past patient records by comparing them against a monitoring system allowing the Health Care Provider to effect compensatory invoicing and collect any difference(s) between their Full Rate(s) and Contracted Rate(s) for rendered services if the patient uses the Health Care Provider's bills for compensation from a First and/or Third Party Payment Entity (e.g., an entity other than the Patient's Health Insurance Entity).

In one implementation, the system may comprise a computer system, and the computer system may further host, interface with, or otherwise enable access to a billing management application for tracking information/contracts for those patients who are seeking payment for healthcare services (either in full or in part) from a First and/or Third Party Payment Entity (other than the Patient's Health Insurance Entity). The billing management application may comprise an “add-on” application to existing or subsequently developed billing applications, or may comprise a separate “stand-alone” application.

In one implementation, the computer system (and billing application) may be in operative communication with one or more external data sources (e.g., legal databases that include information on Court proceedings and other data sources). Information gathered from the one or more external data sources may be maintained, for example, in one or more associated databases. The information may comprise, among other things, information on claims filed by patients (contracting with the Health Care Provider) against any First and/or Third Party Payment Entity (other than the patient's Health Insurance Entity) and the status of any such proceedings related to the claims. The information may also comprise data on any payment-related activities that have occurred between contracted patients and any corresponding First and/or Third Party Payment Entity.

For each patient contracting with the Health Care Provider, the billing management application may generate reports on-demand, or at pre-determined intervals, that include the current status of any efforts by the particular contracting patient to recover money from a First and/or Third Party Payment Entity (other than the patient's Health Insurance Entity).

In one implementation, if a patient has successfully recovered money from a First and/or Third Party Payment Entity, the billing management application may generate, pursuant to the contract between the patient and the Health Care Provider, a bill for the difference between the Health Care Provider's Full Rates (for services rendered by the Health Care Provider to the patient) and the payment received by the Health Care Provider from the Health Insurance Entity at the Contracted Rates.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 is an exemplary illustration of a block diagram illustrating the inter-relationships between parties, according to an aspect of the invention.

FIG. 2 is an exemplary illustration of a processing flowchart, according to an aspect of the invention.

FIG. 3 is an exemplary illustration of a system diagram, according to an aspect of the invention.

### DETAILED DESCRIPTION OF THE PREFERRED EMBODIMENTS

The invention will now be described in detail with reference to the drawing figures, which are provided as illustrative examples so as to enable those skilled in the art to make and use the invention. Notably, the drawing figures and accompanying text (and examples) provided herein are not meant to limit the scope of the invention. In the drawing figures, like components, services, applications, and operations are designated by like reference numerals throughout the various drawing figures. Where certain elements of the invention can be partially or fully implemented using known components, only those portions of such known components that are necessary for an understanding of the present invention may be described, and detailed descriptions of other portions of such known components may be omitted so as not to obscure the invention. Further, the invention encompasses present and future known equivalents to the components referred to herein by way of illustration.

According to an aspect of the invention, a system and method are provided for enabling a Health Care Provider to effect compensatory invoicing of a patient for a Covered Event in instances where the Health Care Provider has contracted with a Health Insurance Entity for provision of health care services to patients at a Contracted Rate, and a First and/or Third Party Payment Entity is liable for payment due to the Covered Event.

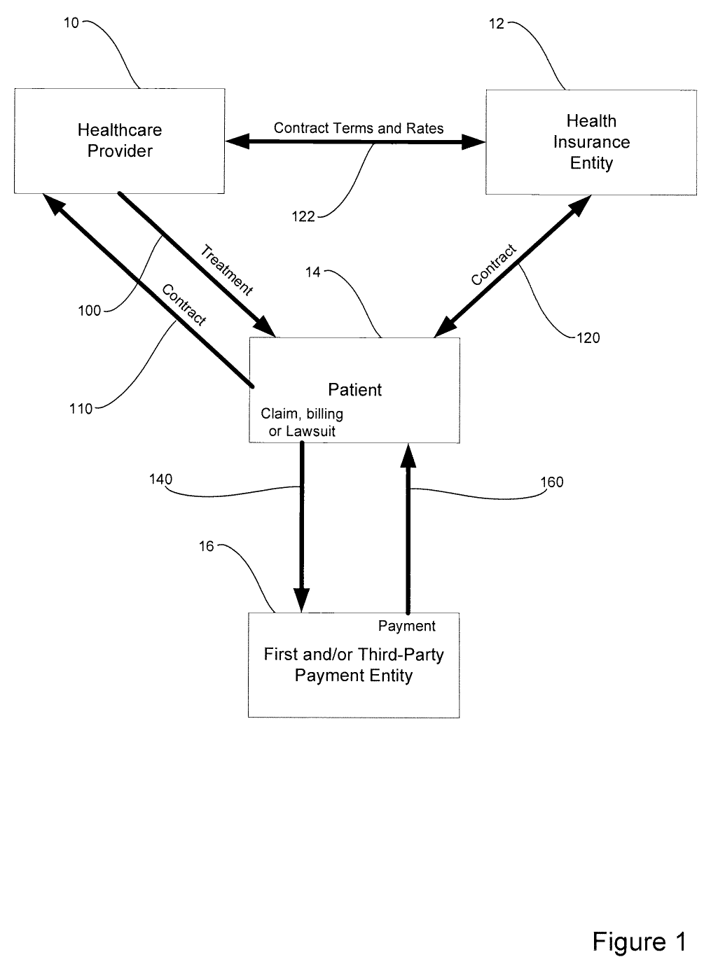

With reference to FIG. 1, the invention enables a Health Care Provider 10 to effect compensatory invoicing of a patient and recoup Full Rates for treatments and services 100 rendered to a patient 14 in those instances wherein patient 14 chooses to also collect payment 140 from a First and/or Third Party Payment Entity 16 in addition to their Health Insurance Entity 12 for treatment or services 100 rendered.

Healthcare Provider 10 may comprise, without limitation, a physician, hospital, or other provider of medical treatment or services. Health Insurance Entity 12, as noted above, may comprise, without limitation, a health insurance company, an MCO, or other provider of health or medical insurance. Examples of First Party Payment Entities include entities through which the patient has MedPay, PIP or other applicable coverage (other than the patient's Health Insurance Entity). Examples of Third Party Payment Entities 16 may include, but are not limited to, collateral sources such as auto insurance carriers, liability and worker's compensation insurance carriers, and other persons or entities that are or may be liable to the patient due to the Covered Event.

By way of background, when Health Care Provider 10 enters into a contract 122 with Health Insurance Entity 12, Health Care Provider 10 typically agrees to contracted billing rates (defined above as the “Contracted Rate”) for providing treatment and services 100 that is often lower than the customary Full Rate charged by Health Care Provider 10 for the service 100. Further, the contract terms 122 between Health Insurance Entity 12 and Health Care Provider 10 typically require Health Care Provider 10 to honor a no-Balance Billing policy that prohibits Health Care Provider 10 from recovering directly from the patient the difference between the Full Rate and Contracted Rate fees for services 100 rendered to patient 14 by Health Care Provider 10. This prohibition also applies to services provided in relation to injuries received in an auto accident, work-related accident, etc. provided that the Health Insurance Entity is the sole source of payment for the service 100.

According to one implementation of the invention, however, a system and method is provided whereby Health Care Provider 10 can identify billing arrangements, inform patient 14 of billing policies, and subsequently enforce a billing contract 110 that would enable the Health Care Provider 10 to be paid at a Full Rate when patient 14 receives compensation 160 from a collateral source (e.g., a First and/or Third Party Payment Entity 16) in addition to the patient's contracted 120 Health Insurance Entity 12.

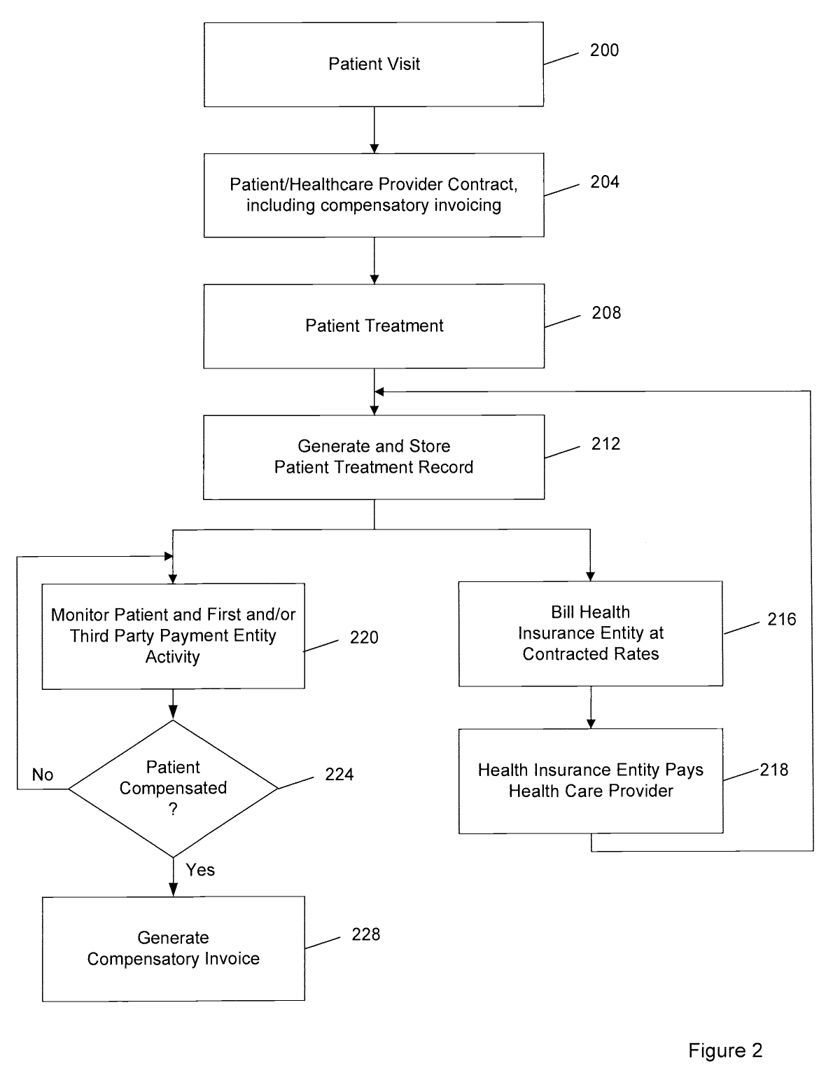

Referring to FIG. 2, an exemplary flowchart of processing operations will now be described. In an operation 200, a Health Care Provider may receive a visit from a new or existing patient seeking medical attention due to injuries, symptoms, or disease stemming from an accident or other event for which a liability insurance product is applicable (defined above as a “Covered Event”), and wherein payment from a First and/or Third Party Payment Entity (other than the patient's Health Insurance Entity) may be anticipated.

In an operation 204, the patient may be provided with a contract to sign specifying the Health Care Provider's billing policies where more than one payment entity is or may be anticipated. The terms of the contract may dictate that the Health Care Provider is entitled to effect compensatory invoicing of the patient to effectively receive payment at the Full Rate (not the Contracted Rate) if the patient uses the Health Care Provider's bills for compensation from a First and/or Third Party Payment Entity in addition to (or other than) the patient's Health Insurance Entity. However, if the patient is not able or chooses not to utilize any additional sources of payment (other than the patient's Health Insurance Entity), even if such payments are available, the Health Care Provider must accept the Contracted Rate from the Health Insurance Entity and not Balance Bill the patient.

Once a signed contract is in place by and between the patient and the Health Care Provider, the Health Care Provider provides necessary services to the patient in the ordinary course, in an operation 208.

In an operation 212, a record of the treatment or services rendered to the patient is made, including billed charges related to treatment/services 208. The record may be maintained via one or more computer systems as a part of the Health Care Provider's billing system and/or through an entity related to the Health Care Provider (i.e., a Medical Billing Company) and/or through an unrelated third party specializing in retrieving such information through data mining or other investigative techniques (hereinafter “Investigative Company”). As detailed below, the one or more computer systems may be configured to track payments made responsive to and/or identify billing payment party sources for the treatment due to the Covered Event. Payments may be made by any combination of the patient's Health Insurance Entity and collateral sources (e.g., a First and/or Third Party Payment Entity).

In an operation 216, the Health Care Provider bills the Health Insurance Entity at the Contracted Rates. In operation 218 the Health Insurance Entity pays the Health Care Provider for the rendered services at the Contracted Rates. This payment may be recorded and associated with the patient record and/or Health Care Provider billing system.

In an operation 220, the Health Care Provider (or someone on behalf of the Health Care Provider) may monitor a variety of sources to determine whether the patient has filed a claim against a First and/or Third Party Payment Entity and/or received compensation from a First and/or Third Party Payment Entity relating to services provided by the Health Care Provider due to a Covered Event.

Operation 220 may include, for example, an electronic (or manual) search of databases or other information sources to determine whether the patient has received or should have received payment based on the Health Care Provider's billing. Monitored sources may, for example, include Court records (electronic or otherwise). It may also include the review of a questionnaire completed by patient prior to treatment, asking if the injury or reason the patient is seeking care stems directly from an accident or other Covered Event. The requesting of treatment records, bills, statements, etc. either by the patient or a representative (agent) of the patient may also be a trigger, alerting the Health Care Provider and related staff (or system if the request is electronically implemented) to the potential ability to effect compensatory invoicing of a patient. Other data sources may be monitored and steps taken to assist the Health Care Provider in identifying when it can effect compensatory invoicing of a patient. Monitoring may be performed manually and/or electronically at pre-determined intervals or otherwise. Any number of configurations and techniques may be implemented. An electronic search may employ techniques including, but not limited to, data mining to obtain information such as claims and payments records associated with the patient. Electronic searches may be conducted to audit records associated with patients having past treatment from Health Care Provider who qualified as injured persons entitled to compensation from plural payers.

In addition, in operation 220, reports may be generated on-demand, or at pre-determined intervals, that include information on any claims filed by patients against any First and/or Third Party Payment Entity (other than the patient's Health Insurance Entity) and the status of any such proceedings related to the claims. The information may also comprise data on any payment-related activities that have occurred between contracted patients and any corresponding First and/or Third Party Payment Entity.

In an operation 224, a determination may be made as to whether the patient has been compensated by a First and/or Third Party Payment Entity for any relevant activity identified in operation 220. If, in operation 224, it is determined that the patient has been compensated by a First and/or Third Party Payment Entity for a Covered Event, a compensatory invoice may be generated in an operation 228. The compensatory invoice may be generated for any difference(s) between the Full Rate(s) of the Health Care Provider and the Contracted Rate(s) for rendered services reimbursed by the Patient's Health Insurance Entity. The bill may be provided to any combination of the patient, a representative of the patient authorized to receive such billing, and/or any person or entity likely to be in possession of monies collected on behalf of the patient.

If a determination is made, in operation 224, that the patient has not yet been compensated by a First and/or Third Party Payment Entity for a Covered Event, then monitoring may continue in operation 220.

It should be recognized that, generally, the prohibition against Health Care Providers Balance Billing their patients, found in typical Health Care Provider/Health Insurance Entity contracts is not violated where the Health Care Provider/patient contract is directed to collect monies via compensatory invoicing of a patient due to payments received by or on behalf of the patient from a First and/or Third Party Payment Entity, which arises when the patient utilizes the bills of the Health Care Provider to collect payments a second or third time (through the Collateral Source Rule with the First and/or Third Party Payment Entity). Unlike Balance Billing, which is when Health Care Providers collect the difference between the Full and Contracted rates when the patient only utilizes a Health Insurance Entity for payment of services, in Compensatory Invoicing, the Health Care Provider is collecting the difference not from the patient directly, but from First and/or Third Party Payment Entities and/or a patient who has received payments from First and/or Third Party Payment Entities in direct relation to said services performed by the Health Care Provider for the patient.

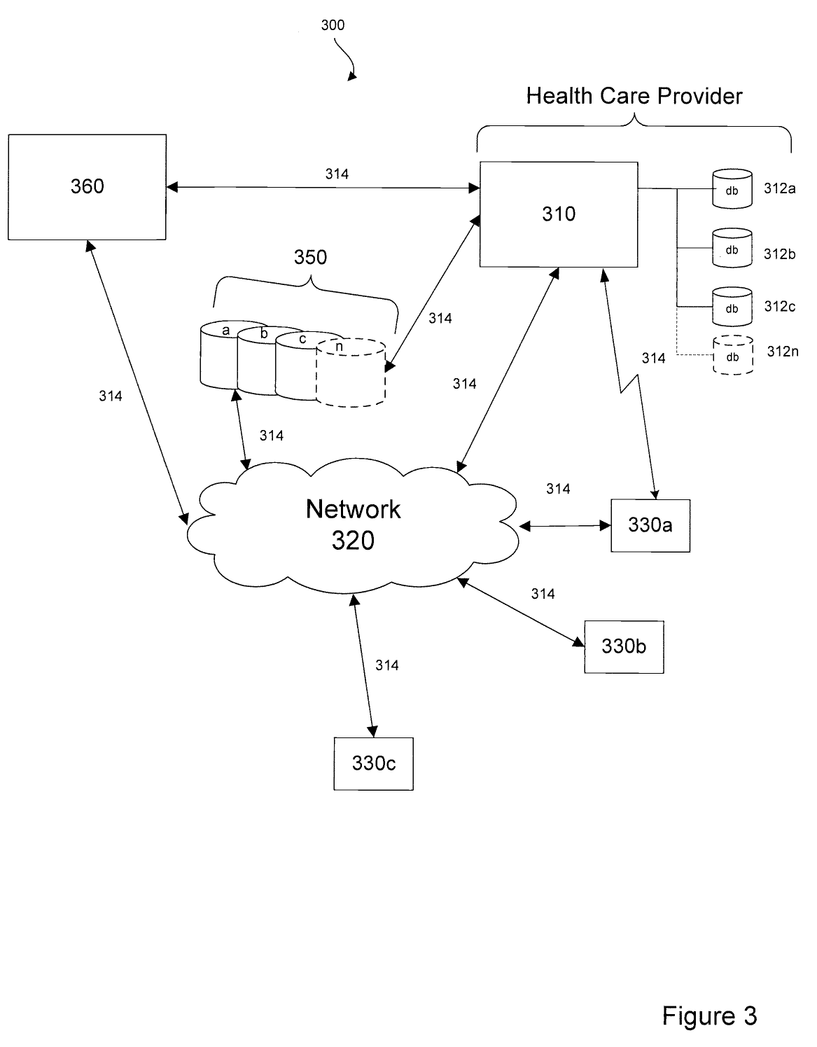

According to an aspect of the invention, as illustrated in FIG. 3, a system 300 may be provided for, among other things, enabling a Health Care Provider to effect compensatory invoicing of a patient for a Covered Event in instances where the patient has contracted with a Health Insurance Entity for provision of health care services at a Contracted Rate and a First and/or Third Party Payment Entity is liable for payment due to the Covered Event.

In one implementation, system 300 may comprise a computer system 310, which is maintained by or on behalf of, associated with, or otherwise accessible by a Health Care Provider. Computer system 310 may comprise a server, personal computer, or other computing device capable of executing software applications. As an exemplary, non-limiting illustration, computer system 310 may comprise a server which may be or include, for instance, a workstation running Microsoft Windows™ NT™, Microsoft Windows™ 2000, Unix, Linux, Xenix, IBM, AIX™, Hewlett-Packard UX™, Novell Netware™, Sun Microsystems Solaris™, OS/2™, BeOS™, Mach, Apache, OpenStep,™ or other operating system or platform.

In one implementation, computer system 310 may host a billing management application for, among other things, tracking information/contracts for those patients who are seeking payment for healthcare services (either in full or in part) from a First and/or Third Party Payment Entity (other than the patient's Health Insurance Entity). In some implementations, the billing management application may comprise a “stand-alone” application. Alternatively, the billing management application may comprise an “add-on” application to existing or subsequently developed billing applications.

In an alternative implementation, the billing management application may be hosted by a computer system (e.g., one or more servers) 360 associated with a service provider, and computer system 310 may be directly linked to computer system 360 via a communications link 314. Alternatively, computer system 360 (and the billing management application) may be accessed over a network 320 (via a communications link 314) by a user of computer system 310.

Network 320 may include, but is not limited to, any one or more of, for instance, the Internet, an intranet, a PAN (Personal Area Network), a LAN (Local Area Network), a WAN (Wide Area Network), a SAN (Storage Area Network), or a MAN (Metropolitan Area Network).

Communications link 314 may include, but is not limited to, any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, or a wireless connection.

According to an aspect of the invention, one or more databases (312a, 312b, . . . 312n) may be operatively connected to the Health Care Provider computer system 310. The one or more databases (312a, 312b, . . . 312n) may be locally accessible by computer system 310. In alternative implementations, security or other operational considerations may dictate that the one or more databases (312a, 312b, . . . 312n) be physically maintained in a different location from computer system 310, and accessed through a private network. Other configurations may be implemented.

The one or more databases (312a, 312b, . . . 312n) may be, include, or interface to, for example, an Oracle™ relational database sold commercially by Oracle Corporation. Other databases, such as Informix™, DB2 (Database 2) or other data storage or query formats, platforms, or resources such as OLAP (On Line Analytical Processing), SQL (Standard Query Language), a SAN (storage area network), Microsoft Access™ or others may also be used, incorporated, or accessed into the invention.

Patient data, billing records, and information corresponding to various Health Insurance Entities and Third Party Payment Entities are non-limiting examples of the types of information that may be stored in one or more databases (312a, 312b, . . . 312n). Such information might also be non-electronic and be stored, monitored and interpreted appropriately.

According to an aspect of the invention, the billing management application may be utilized to generate and/or update patient records for each patient seeking treatment from a Health Care Provider. As will be appreciated by those having skill in the art, patient records may include data including, but not limited to, personal information, medical history information, billing and payment information, information on Health Insurance Entities, and a record of treatment and/or services rendered.

According to an aspect of the invention, if a patient is seeking medical attention to injuries, symptoms, or disease stemming from an accident or Covered Event for which a liability insurance product is applicable, and wherein payment from a First and/or Third Party Payment Entity (other than the patient's Health Insurance Entity) may be anticipated, the billing management application (or other application) may generate a contract for execution by the patient and the Health Care Provider. As described in detail above, the terms of the contract may dictate that the Health Care Provider be entitled to receive payment at a Full Rate (not the Contracted Rate) if the patient uses the Health Care Provider's bills for compensation from a First and/or Third Party Payment Entity in addition to (or other than) the patient's Health Insurance Entity. Additionally, or as part of the contract, the application may generate a form or provisions that require the patient to identify any First and/or Third Party that may be liable to the patient for the Covered Event.

Once a signed contract is in place by and between the patient and the Health Care Provider, a copy of the contract may be scanned (or otherwise duplicated electronically) and appended to the patient's record for later retrieval via the billing management application. Via Optical Character Recognition (OCR) or other technology specific information from the contract and/or questionnaire may be entered into a database for subsequent tracking by or on behalf of the Health Care Provider to assist in effecting compensatory invoicing of a patient, when appropriate. Manual entry of information into a database may also be performed.

Once a patient has been treated, the patient's record may be updated with information corresponding to the treatment or services rendered to the patient. The billing management application may then handle the billing of the patient's Health Insurance Entity (at the Contracted Rates). Where appropriate (e.g., when the questionnaire indicates there may be a First and/or Third Party Payment Entity, when the treatment/services are due to a Covered Event or when otherwise appropriate), the patient's record may be identified or “flagged” by the billing management application as a matter requiring the monitoring (or tracking) of liability claims associated with the treatment and/or subsequent monitoring and/or data mining may generate an alert to flag the patient record as described elsewhere herein to determine when and/or whether the Health Care Provider may effect compensatory invoicing of the patient.

According to an aspect of the invention, as part of the follow-up for “flagged” patient records (and/or to generate flags), the billing management application (or a service provider) may monitor a variety of external data sources (350a, 350b, . . . 350n) to determine whether the patient has filed a claim against a First and/or Third Party Payment Entity and/or received compensation from a First and/or Third Party Payment Entity relating to services provided by the Health Care Provider. The flag may be cleared when payment on the compensatory invoice has been made and/or received and/or when a compensatory invoice is issued.

The one or more external data sources (350a, 350b, . . . 350n) may be directly or indirectly networked to computer system 310, or operatively connected to computer system 310 via any suitable network 320. According to one implementation, one or more external data sources (350a, 350b, . . . 350n) may comprise one or more computers (e.g., servers), databases, Internet web sites, or other host sites or applications, or any combination thereof, and may comprise publicly-accessible data and/or private data requiring subscriptions and/or access authorization. In certain instances, such authorization may be granted by the patient (or an agent authorized to act on the patient's behalf), or by another person or entity.

The one or more external data sources (350a, 350b, . . . 350n) may be utilized to gain access to information related to, among other things, medical diagnostic codes, unedited medical claims, Court records of legal proceedings including docketing information and decisions in related cases in State and Federal Courts. The information may further comprise information identifying the patient, the patient's legal representative including attorney-at-law, attorney-in-fact, legal guardian, and estate. The one or more external data sources (350a, 350b, . . . 350n) may also comprise information identifying persons, entities and organizations involved in transfers of payments associated with the performance of services by the Health Care Provider, including escrow agents, the patient's legal representatives, and insurance companies.

In one implementation, the billing management application may execute search functions, data-mining functions, or other functions to acquire relevant information from the one or more external data sources (350a, 350b, . . . 350n). A Health Care Provider or other user may cause the billing management application to execute these functions on-demand, or at pre-determined intervals. Acquired data may then, for example, be stored in the one or more databases (312, 312b, . . . 312n) associated with computer system 310.

In an alternative implementation, any of the aforementioned information may also be provided to the billing management application via transfer of media including, for example, Blu-Ray disk, DVD, CD-ROM, memory stick, tape, disk, and/or other suitable removable media, wireless means, as well as paper records. In this implementation, the Health Care Provider may cause the billing management application to request updates and new records from external information sources as necessary to maintain consistency and currency of information in the one or more associated databases (312a, 312b, . . . 312n).

Certain implementations may employ a combination of on-line access (to external data sources (350a, 350b, . . . 350n), and removable media to access information necessary to track third party billing and payments.

According to an aspect of the invention, the billing management application can respond to queries and provide reports to, among other persons or entities, Health Care Providers and Health Care Providers' staff. In certain implementations, reports may be provided on demand, upon the occurrence of certain events at desired intervals, including, for example, daily, weekly, and/or monthly intervals or at other times. Reports may be customizable, and may identify the status of billing processes (including compensatory invoicing) for one or more patients, and may identify delinquencies and delayed payments.

In one implementation, reports may also identify events for patients that may be of particular significance to the Health Care Provider including, for example, filing of claims against First and/or Third Party Payment Entities, entries of judgment against Third Party Payment Entities, payments by First and/or Third Party Payment Entities and other events or information.

Reports may be provided in any number of customizable formats to users of computer system 310. Additionally, reports may be accessible by (or provided in an outbound communication) to users via any number of client devices (330a, 330b, . . . 330n) in any number of formats. Examples of client devices (330a, 330b, . . . 330n) may include, but are not limited to, personal computers, portable computers, PDAs (personal digital assistants), workstations, mobile phones, web-enabled mobile phones, WAP devices, web-to-voice devices, or other devices.

In one implementation, information may be further provided by an interactive voice response (IVR) system configured to access the billing management application upon the request of authorized users, and provide information via audio output.

According to an aspect of the invention, upon confirmation of payment by a First and/or Third Party Payment Entity to patient, the billing management application may generate a compensatory invoice for the patient and/or any agent of the patient, (e.g., their attorney) for the difference between the Full Rate and the Contracted Rate.

Those having skill in the art will appreciate that the invention described herein may work with various system configurations. Accordingly, more or less of the aforementioned system components depicted in FIG. 3 (and described above) may be used and/or combined in various implementations.

Additionally, according to a business method, a service provider may provide and/or use the described systems and/or perform described services on behalf of multiple Health Care Providers to implement one or more of the steps described herein with respect to: i) identifying when treatment/services rendered by a Health Care Provider relates to a Covered Event; ii) identify one or more First and/or Third Party Payment Entity; iii) determine when compensatory invoicing is appropriate; and/or iv) effect, when appropriate, compensatory invoicing of the patient on behalf of the relevant Health Care Provider. According to this business method the service provider may bill the Health Care Provider in a number of different ways including fixed fees per month (or other period); a fixed fee per patient/covered event monitored; based on a percentage of any recoveries received due to the compensatory invoicing of any patient; and/or otherwise.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A health care provider billing method utilized with a patient who has health insurance provided by a health insurance entity, where the health care provider and health insurance entity have entered into a billing contract whereby the health care provider agrees to bill a patient covered by the health insurance entity at contracted rates which may be lower than full rates established by the health care provider for services given to the patient, and which precludes the health care provider from directly balance billing the patient for the difference between the contracted rates and the full rates, except when a separate payment entity, other than the health insurance entity is liable to the patient for a covered event related to the services, the billing method comprising:
the health care provider entering into a billing contract with a patient, where the billing contract includes a provision that enables the health care provider to effect compensatory invoicing, allowing for collection of monies from a separate payment entity and/or the patient, who has received monies from a separate payment entity other than the health insurance entity, the difference between the contracted rates and the full rates;
providing medical services to the patient;
billing the health insurance entity for the services at the contracted rate;
identifying a separate payment entity other than the health insurance entity or patient who may be liable to the patient for payment related to the provided services due to the covered event; and
effecting compensatory invoicing, thereby billing the identified payment entity and/or the patient who has received monies from an identified payment entity for the difference between the contracted rates and the full rates.

2. The method of claim 1, wherein the identified payment entity is a first party payment entity and is liable to the patient due to MedPay or Personal Injury Protection.

3. The method of claim 1, wherein the need for the provided services arises from a covered event for which a liability insurance product is applicable, and the identified payment entity is a third party payment entity and/or liability insurance provider who provides insurance to an entity who caused the covered event.

4. The method of claim 1, wherein the identified payment entity is a Medpay provider for an insurance product of the patient.

5. The method of claim 1, wherein the identified payment entity is a Personal Injury Protection provider for an auto insurance product of the patient.

6. The method of claim 1, wherein the step of identifying an entity comprises monitoring a variety of sources to determine whether the patient has filed a claim with and/or against a payment entity, other than the patient's health insurance entity, relating to services provided to the patient by the health care provider.

7. The method of claim 1, wherein the step of identifying comprises auditing past patient records by comparing them against a monitoring system allowing the health care provider to effect compensatory invoicing, collecting any differences between the full rates and the contracted rates for rendered services if the patient uses the health care provider's bills for compensation from a payment entity other than the patient's health insurance entity.

8. The method of claim 1, further comprising the step of questioning the patient, prior to, during or after the provision of services, to determine whether there is an entity other than the health care provider or patient who may be liable to the patient for payment related to the provided services;

9. The method of claim 1, further comprising the step of monitoring requests for transfer or copies of patient treatment records or bills to identify or flag situations where a separate payment entity other than the patient's health insurance entity may be liable to the patient for payment relating to the provided services.

10. A computer implemented system for enabling a health care provider to effect compensatory invoicing of a patient who has health insurance provided by a health insurance entity, where the health care provider and health insurance entity have entered into a billing contract whereby the health care provider agrees to bill patients covered by the health insurance entity at contracted rates which may be lower than full rates established by the health care provider for the services and which precludes the health care provider from directly balance billing the patient for the difference between the contracted rates and the full rates except when a separate payment entity, other than the health insurance entity, is liable to the patient for a covered event related to the services, the system comprising:
means for storing in the system an indication that the patient and the health care provider have entered into a billing contract, where the billing contract includes a provision that enables the health care provider to effect compensatory invoicing, collecting from a separate payment entity and/or the patient, who has received monies from an identified payment entity other than the health insurance entity, for the difference between the contracted rates and the full rates;
means for billing the health insurance entity at the contracted rate, for the services provided to the patient;
means for identifying a separate payment entity, other than the health care provider or patient, who may be liable to the patient for payment related to the provided services due to the covered event; and
means for billing the identified payment entity and/or the patient, who has received monies from an identified payment entity for the difference between the contracted rates and the full rates.

11. The system of claim 10, wherein the identified payment entity is a first party payment entity and is liable to the patient due to MedPay or Personal Injury Protection.

12. The system of claim 10, wherein the need for the provided services arises from a covered event for which a third party payment entity and/or liability insurance product is applicable, and the identified payment entity is a liability insurance provider who provides insurance to an entity who caused the covered event.

13. The system of claim 10, wherein the identified payment entity is a Medpay provider for an insurance product of the patient.

14. The system of claim 10, wherein the identified payment entity is a Personal Injury Protection provider for an auto insurance product of the patient.

15. The system of claim 10, wherein means for identifying a payment entity comprises means for monitoring a variety of sources to determine whether the patient has filed a claim with and/or against a payment entity, other than the patient's health insurance entity, relating to services provided to the patient by the health care provider.

16. The system of claim 10, wherein means for identifying a payment entity comprises means for auditing past patient records by comparing them against a monitoring system to flag situations where the health care provider may effect compensatory invoicing, thereby collecting for any differences between the full rates and the contracted rates for rendered services if the patient uses the health care provider's bills for compensation from a separate payment entity other than the patient's health insurance entity.

17. The system of claim 10, further comprising means for storing responses by the patient to a questionnaire determining whether there is a payment entity other than the health insurance entity-which may be liable to the patient for payment related to the provided services;

18. The system of claim 10, further comprising means for monitoring requests for transfer or copies of patient treatment records or bills to identify or flag situations where a separate payment entity other than the patient's health insurance entity may be liable to the patient for payment relating to the provided services.

19. A method for assisting health care providers in effecting compensatory invoicing of patients who have health insurance provided by a health insurance entity, where for a health care provider and health insurance entity have entered into a billing contract whereby the health care provider agrees to bill patients covered by the health insurance entity at contracted rates which may be lower than full rates established by the health care provider for the services and which precludes the health care provider from directly balance billing the patient for the difference between the contracted rates and the full rates, except when a separate payment entity, other than the health insurance entity, is liable to the patient for a covered event related to the services and where the health care provider has entered into a billing contract with the patient prior to rendering services, where the billing contract includes a provision that enables the health care provider to collect from a separate payment entity and/or the patient, who has received monies from a payment entity, other than the health insurance entity, for the difference between the contracted rates and the full rates, the method comprising:
a service provider entering into a contract with one or more health care provider(s) to provide services to assist the one or more health care providers in effecting compensatory invoicing of patients, where appropriate, in exchange for a fee paid by the one or more health care providers to the service provider, wherein the services provided by the service provider include one or more of:
i) identifying when treatment/services rendered by a health care provider relates to a covered event; ii) identify one or more payment entity other than a health insurance entity that may be liable to the patient for the services due to the covered event; and/or iii) effecting, when appropriate, compensatory invoicing of the separate payment entity and/or the patient, who has received monies from a separate payment entity other than the health insurance entity, said monies being the difference between the contracted rates and the full rates, on behalf of the relevant health care provider.

20. The method of claim 19, wherein the services provided by the service provider include billing, on behalf of the health care provider to a first party payment entity such as MedPay and/or Personal Injury Protection policies.

21. The method of claim 19, wherein the services provided by the service provider include billing, on behalf of the health care provider to a third party payment entity and/or liability insurance provider who provides insurance to an entity who caused the covered event.

22. The method of claim 19, wherein the services provided by the service provider include monitoring a variety of sources to determine whether a patient of the one or more health care providers has filed a claim with and/or against a separate payment entity, other than the patient's health insurance entity, relating to services provided to the patient by the health care provider.
